(19) United States
(12) Patent Application Publication
(10) Pub. No.: US 2026/0268164 A1
(43) Pub. Date: Sep. 10, 2026

(54) REDUCING RESOURCE UTILIZATION IN MACHINE LEARNING MODEL PROCESSING

(71) Applicant: INTERNATIONAL BUSINESS MACHINES CORPORATION, ARMONK, NY (US)

(72) Inventors: HOSAM ALY, KANATA (CA); RAMI ABOU-NASSIF, OTTAWA (CA)

(21) Appl. No.: 19/074,948

(22) Filed: Mar. 10, 2025

(51) Int. Cl. G06N 3/10; G06N 3/0475

(52) U.S. Cl. CPC G06N 3/10; G06N 3/0475

(57) ABSTRACT

Reducing resource utilization in machine learning model processing, including: receiving a first query for machine learning model processing; receiving a response to the first query, wherein the response comprises an output from a particular machine learning model that processed the first query; determining, via natural language processing performed via a computer, that the first query includes a time-relative expression; storing a cache entry comprising the response to the first query and a time-to-live; receiving, at a time within the time-to-live, a second query for machine learning model processing; semantically analyzing the second query to determine that the second query has a similarity to the first query that exceeds a threshold value; retrieving the response from the cache entry; and transmitting the retrieved response to be an answer to the second query.

### BACKGROUND

The present disclosure relates to methods, apparatus, and products for reducing resource utilization in machine learning model processing.

### SUMMARY

According to embodiments of the present disclosure, various methods, apparatus and products for reducing resource utilization in machine learning model processing are described herein. In some aspects, reducing resource utilization in machine learning model processing includes receiving a first query for machine learning model processing; receiving a response to the first query, wherein the response comprises an output from a particular machine learning model that processed the first query; determining, via natural language processing performed via a computer, that the first query includes a time-relative expression; storing a cache entry comprising the response to the first query and a time-to-live; receiving, at a time within the time-to-live, a second query for machine learning model processing; semantically analyzing the second query to determine that the second query has a similarity to the first query that exceeds a threshold value; retrieving the response from the cache entry; and transmitting the retrieved response to be an answer to the second query. In some aspects, a computer system may include a processor set; one or more computer-readable storage media; and program instructions stored on the one or more storage media to cause the processor set to perform operations comprising this method. In some aspects, a computer program product may include: one or more computer-readable storage media; and program instructions stored on the one or more storage media to perform operations comprising this method.

### BRIEF DESCRIPTION OF THE DRAWINGS

FIG. 1 sets forth an example computing environment according to aspects of the present disclosure.

FIG. 2 sets forth an example process flow for reducing resource utilization in machine learning model processing in accordance with some embodiments of the present disclosure.

FIG. 3 sets forth another example process flow for reducing resource utilization in machine learning model processing in accordance with some embodiments of the present disclosure.

FIG. 4 sets forth a flowchart of an example method for reducing resource utilization in machine learning model processing in accordance with some embodiments of the present disclosure.

FIG. 5 sets forth a flowchart of another example method for reducing resource utilization in machine learning model processing in accordance with some embodiments of the present disclosure.

### DETAILED DESCRIPTION

Use of machine learning models, including generative artificial intelligence (AI) models such as large language models (LLMs), may incur significant costs due to the computational resources required for their use. Cached responses may be used to reduce the need to access models for all queries, thereby reducing overall costs and resource expenditures and improving response time, but this process may be complicated due to some responses only being relevant within certain time frames. Moreover, different models vary in response time, accuracy, and the costs incurred through their use. Typically, models with higher accuracy will also have higher usage costs due to requiring greater amounts of computational resources compared to other models. Accordingly, when multiple models are available for use, both the accuracy of the models and their associated costs must be taken into consideration when selecting a model to use. For example, using lower-cost models may result in overall cost savings but may not always produce accurate results. As another example, higher-accuracy models may produce accurate results more consistently but at greater cost and response time.

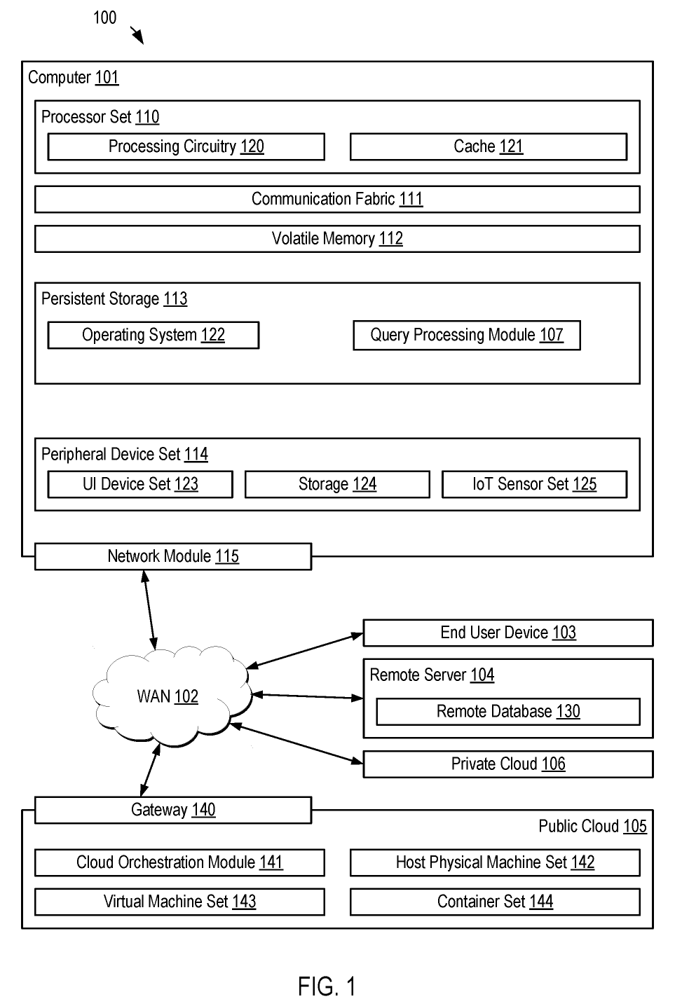

With reference now to FIG. 1, shown is an example computing environment according to aspects of the present disclosure. Computing environment 100 contains an example of an environment for the execution of at least some of the computer code involved in performing the various methods described herein, such as the query processing module 107. In addition to the query processing module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the query processing module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer-readable program instructions are stored in various types of computer-readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in the query processing module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the query processing module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

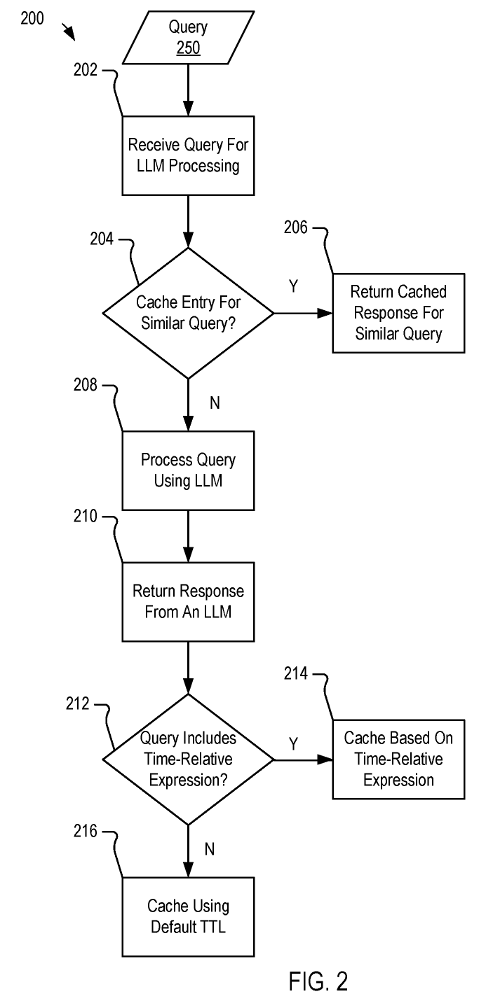

FIG. 2 shows an example process flow 200 for reducing resource utilization in machine learning model processing in accordance with some embodiments of the present disclosure. To begin, at block 202, a query 250 for large language model (LLM) processing is received. Although the following discussion is presented in the context of an LLM, readers will appreciate that the approaches set forth herein may be applied to any type of machine learning model as can be appreciated. An LLM is a particular type of generative artificial intelligence (AI) machine learning model trained to process natural language expressions. As referred to herein, generative AI uses models such as neural networks, including LLMs, large multimodal models (LMMs), and the like to generate content, such as text, code, graphics, animations, video, audiovisual representations, audio, speech, etc., in response to prompts. The generative AI models are trained using a corpus of training data content to learn the patterns and structure of that content. The generative AI model may then generate new content having the characteristics learned from the training data. Prompts may include text, code, audio, graphics, video, and/or representations in any other media. Such prompts may be provided to the generative AI model as a natural language input. For example, the approaches set forth herein may interact with a generative AI model using predefined prompts, dynamically generated prompts, prompts that include some portion of dynamically generated content (e.g., through the use of templates and dynamically populated variables), and/or the like.

Here, the query 250 is a query 250 to be processed using an LLM of multiple possible LLMs. The query 250 may include, for example, a natural language expression or other query received from a user or some other entity. For example, in some embodiments, the query 250 may include text input received via a natural language interface for some system. In some embodiments, the query 250 may include a portion of data, such as text, to be included in a prompt to an LLM. For example, in some embodiments, the query 250 may include data that may be inserted into a prompt template to generate a prompt to an LLM. As another example, in some embodiments, the query 250 may include the prompt itself.

At block 204, a determination is made as to whether a cache stores a cache entry for a query similar to the received query 250. In some embodiments, the cache serves to map previously received queries to responses generated by processing those queries using an LLM. In some embodiments, the cache stores entries with some time-to-live (TTL) value that determines when an entry should be evicted from the cache. This cache may be used, for example, to reduce the amount of computational resources required to service queries 250 similar to some recently received query. In some embodiments, the cache may map queries 250 to responses by mapping embeddings of queries 250 to their responses or the embeddings of their responses. An embedding is a vector encoding of input data that maps the input data to a point in multidimensional space. Readers will appreciate that encoders that convert data into vector embeddings are known components of neural networks or other machine learning models for converting input data into numerical forms that may be processed by the model. Accordingly, in some embodiments, the cache may be implemented using a vector database. For example, a vector database may be used to store vector embeddings for queries 250 mapped to addresses or identifiers for their responses as stored in cache memory.

In some embodiments, to determine whether the cache stores an entry for a similar query 250, an embedding is generated for the received query 250. The embedding for the received query 250 may then be compared to embeddings mapped to the cache in a vector database to determine if any of the embeddings are similar to the embedding of the received query 250. For example, in some embodiments, as these embeddings are points in multidimensional space, the similarity between two embeddings may be evaluated as a distance between these two multidimensional points. This distance may be calculated using any multidimensional distance function as can be appreciated, including Euclidian distance, cosine distance, and the like. A cache entry may be determined to be similar to the query 250 where the distance between their respective embeddings falls below some threshold value.

In some embodiments, if the cache stores an entry for a query similar to the received query 250, the process advances to block 206 where the response stored in the cache entry is returned in response to the query 250. This may include returning the response to a user or other entity that provided the query 250. This use of the cached response eliminates the need for the received query 250 to be processed by an LLM to generate a response, reducing the amount of computational resources required to service the received query 250. Moreover, as the cache is accessed using semantic similarity analysis, the cache need not store an entry for an exact match to the received query 250. In some embodiments, where multiple cache entries are determined to be similar to the query 250, a most similar cache entry may be selected as having the least distance between its embedding and the embedding of the query 250. The response stored in this most similar cache entry may then be returned in response to the query 250.

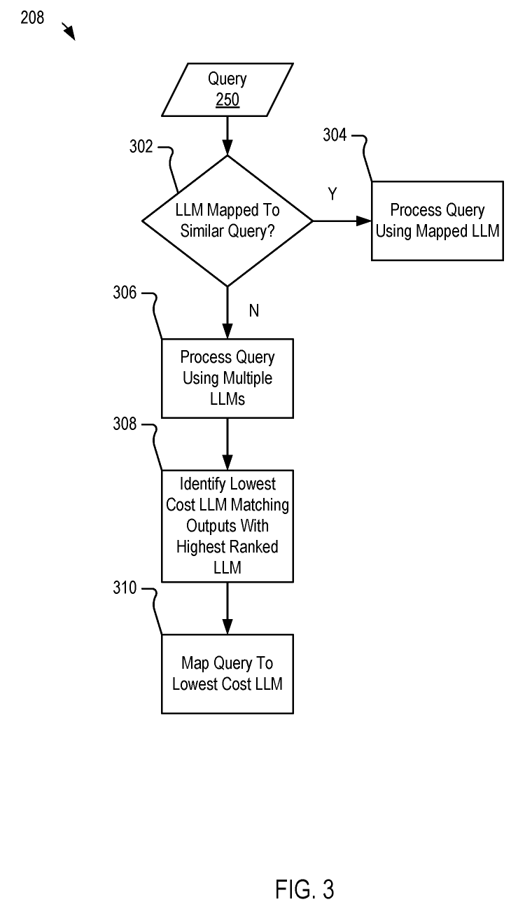

In some embodiments, if the cache does not store an entry similar to the received query 250, the process advances to block 208 whereby the query 250 is processed using an LLM to generate a response for the query 250. Particular approaches for how the query 250 is processed using an LLM are discussed in further detail in FIG. 3. At block 210 a response from an LLM that processed the query 250 is returned in response to the query 250.

At block 212, a determination is made as to whether the query 250 includes a time-relative expression. A time-relative expression is a natural language expression, such as one or more keywords or phrases, that indicate a time period to which the query 250 applies. In some embodiments, where the query 250 includes a question or request for information, the time-relative expression may define a time period to which the query 250 relates. Particularly, in some embodiments, the time-relative expression may include an expression that must be interpreted or disambiguated relative to the time at which the query 250 was received. In other words, a time-relative expression may change the response to the query 250 depending on when the query 250 was received.

As an example, assume that the query 250 includes the question, “What was the highest-grossing movie last week?” In this example, “last week” is a time-relative expression as it defines time constraints for information to be used by the LLM in processing the query 250 (e.g., movie box office information for the last week). Moreover, this is a time-relative expression as it is relative to the time at which the query 250 was received. For example, if this same query 250 was received across different weeks the response to the query may change. Accordingly, the response for the received query 250 may not be applicable in subsequent weeks. As another example, where the query 250 includes the question, “What is the weather in Atlanta today?” the response to this question will only be applicable to the day in which the query 250 was received. Thus, the word “today” serves as a time-relative expression.

In some embodiments, determining whether the query 250 includes a time-relative example may include providing the query 250 to a machine learning model that provides, as output, an indication as to whether the query 250 includes a time-relative expression and/or an indication of a time-relative expression in the query 250, where present. In some embodiments, this machine learning model may provide, as output, a time window or duration that the time-relative expression will be applicable. Returning to the example above for the query 250 “What is the weather in Atlanta today,” where the request was received on January 1, 2025, the machine learning model may provide an output indicating that the response to the query 250 will only be applicable until midnight on January 1, 2025.

A machine learning model used to determine whether the query 250 includes a time-relative expression may include an LLM or another machine learning model capable of natural language processing. Readers will appreciate that, as LLMs are well-suited for summarizing, processing, or describing input text data, this LLM may include a general-purpose or off-the-shelf LLM not specifically trained for identifying time-relative expressions. This LLM is accessed for the task using a specific prompt that inputs the query into the LLM with a natural language request to check for a time-relative expression within the query. Such prompt building is automated in at least some embodiments. In some embodiments, a specifically trained machine learning model may also be used. For example, such specifically trained machine learning model needs no special prompt and simply performs the query analysis (to check for any time-relevant expression) in response to receiving the query as input. In some embodiments, other approaches may also be used for determining whether the query 250 includes a time-relative expression, such as keywork or expression matching or other natural language processing algorithms as can be appreciated.

If the query 250 includes a time-relative expression the process advances to block 214 where an entry is stored in the cache based on the time-relative expression. This entry may store the response provided by the LLM that processed the received query 250. A vector database entry may be created that maps the cache entry to the embedding of the received query 250. As is set forth above, the TTL value serves to indicate when the entry can be evicted from the cache. In other words, the TTL value includes a duration that the entry may be stored in the cache before automatically being evicted. In some embodiments, where the query 250 includes a time-relative expression, the entry may be stored with a TTL value corresponding to a time window in which the mapped response will be applicable.

Returning to the examples above, for a query 250 asking “What is the weather in Atlanta today?” a cache entry may be stored with a TTL ending on the day when the query 250 was received. As another example, for a query 250 asking “What was the highest-grossing movie last week?” a cache entry may be stored with a TTL ending at the end of the week when the query 250 was received. As is set forth above, in some embodiments, the translation or conversion of time-relative expressions to times-to-live may be performed by a machine learning model that determines whether the query includes a time-relative expression. Here, a duration or time window of applicability output by the machine learning model may be used as the TTL for the corresponding cache entry.

If the query 250 does not include a time-relative expression the process advances to block 216 where an entry mapping the query 250 to its response is stored in cache using some default TTL value. Readers will appreciate that, using these approaches, LLM queries 250 with time-relative expressions may be serviced using cached responses that are stored based on their time-relative expressions. This use of TTL values for governing length of stay within the cache may allow for cache entries to be stored for longer periods of time than when using a default TTL, such as where the time-relative expression covers a relatively long time period. This use of TTL values for governing length of stay within the cache may also allow for cache entries to be evicted earlier than when using a default TTL, such as when the time-relative expression covers a relatively short period of time. This use of TTL values for governing length of stay within the cache improves overall cache efficiency and performance.

Turning next to FIG. 3, shown is another example process flow 208 for processing a query 250 using an LLM. FIG. 3 represents an enlargement or detailed view of the individual block 208 shown in FIG. 2. In the process flow of FIG. 3, the query 250 will be processed by an LLM as there was no cache entry for a query similar to the received query 250. Particularly, FIG. 3 shows a process flow for processing the query 250 using one or more of multiple LLMs. In some embodiments, a system for processing queries 250 to an LLM may implement multiple different LLMs. Each LLM may include, for example, different versions of a single base model, LLMs from different providers that are trained and encoded using different approaches, and the like.

In some embodiments, each LLM may require different amounts of computational resources to process a query 250. In other words, the computational complexity and resource usage for processing a query 250 may vary amongst the different LLMs. The amount of computational resources used by a particular LLM in processing a query 250 is hereinafter referred to as the “cost” of the LLM. This cost may relate or correspond to an actual financial cost in using the LLM due to the amount of computational resources used. In some embodiments, this cost may correspond to a cost to use the LLM from a third-party provider. Moreover, in some embodiments, each LLM may have different levels of accuracy in processing queries 250. For example, in some embodiments, the most accurate LLM may also correspond to the highest cost LLM as that LLM expends more computational resources to service a given query 250.

To begin, at block 302, a determination is made as to whether an LLM of the multiple LLMs is mapped to a query similar to the received query 250. In some embodiments, a model routing database may store entries that map queries, hereinafter referred to as sample queries, to one of the multiple LLMs. In some embodiments, the model routing database includes a vector database that maps embeddings of sample queries to one of the multiple LLMs. An entry in the model routing database serves to indicate that queries such as the received query 250 that are similar to the entry (e.g., similar to the sample query stored in the entry) should be processed by the mapped LLM. Particularly, in some embodiments, an entry in the model routing database maps a sample query to a lowest-cost LLM that produced an accurate response to the sample query. Approaches for adding entries to the model routing database will be described in further detail below.

Where the model routing database maps an LLM to a sample query similar to the received query 250, the mapped LLM should be used to process the received query 250. Similarity between sample queries and the received query 250 may be evaluated and determined according to similar approaches as are set forth above. For example, a distance between an embedding of a sample query and the received query 250 in multidimensional space may be calculated. For samples in which this distance falls below some threshold, that sample query may be determined to be similar to the received query 250. Accordingly, where an LLM is mapped to a similar sample query in the model routing database, the process advances to block 304 where the received query 250 is processed using the mapped LLM. This may include, for example, providing the query 250 as input to the LLM (e.g., as a prompt or included in a prompt) and receiving some output from the LLM. The output from this LLM may then be used as a response to the received query 250.

Otherwise, if the model routing database does not store an entry for a sample query similar to the received query 250, the process advances to block 306 where the query 250 is processed using each of the multiple LLMs (e.g., in parallel). This processing using multiple LLMs produces multiple outputs, one output from each LLM. Next, in block 308, a lowest cost LLM matching outputs with a highest ranked LLM is identified. As is set forth above, each LLM may have an associated cost based on the amount of computational resources used by the LLM in processing queries. Accordingly, each LLM may be categorized, tagged, or otherwise classified based on their cost. For example, assuming three LLMs, these LLMs may include a high-cost LLM, a medium-cost LLM, and a low-cost LLM. In this example, it is presumed that the costs associated with each LLM have been evaluated in advance so as to categorize or classify the LLMs. In other words, it is assumed that each LLM has been designated some predefined cost or cost classification.

Each LLM may also be ranked according to their accuracy. Again, in some embodiments, it may be presumed that the accuracy of each LLM has been evaluated in advance so as to rank the LLMs. In some embodiments, the accuracy, and therefore the rank, of an LLM may be based on the cost associated with the LLM. For example, in some embodiments, it may be presumed that the highest-cost LLM is also the highest-accuracy LLM. Returning to the example above with a high-cost, medium-cost, and low-cost LLM, the high-cost LLM may be assigned the highest rank, the medium-cost LLM may be assigned the next-highest rank, and the low-cost LLM may be assigned the lowest rank.

Assuming that the output of the highest-ranked LLM is the most accurate, the outputs from the other LLMs to determine if any of the other LLMs produced a matching output. In some embodiments, an output may be matching based on an exact match or a similar match. For example, in some embodiments, two outputs may be deemed to match where the distance between their respective embeddings exceed some threshold. As another example, in some embodiments, the highest-ranked LLM or some other machine learning model may be provided the outputs from all LLMs as input. This machine learning model may then evaluate these outputs to determine which outputs, if any, are similar enough to the output of the highest-ranked LLM to be deemed a match. As the highest-ranked LLM is presumed to provide accurate outputs, other matching outputs are also presumed to be accurate.

As an example, assume LLMs A, B, and C, with LLM A having the highest rank (e.g., accuracy) and cost, LLM B having the next-highest rank and cost, and LLM C having the lowest rank and cost. Further assume, that these LLMs produce outputs a, b, and c, respectively. Outputs b and c are compared to output a. Where outputs b and c match output a, LLM C will be identified as the lowest-cost LLM that has matching outputs with the highest-ranked LLM A. Where output b matches output a but output c does not match output a, LLM B will be identified as the lowest-cost LLM that has matching outputs with the highest-ranked LLM A. Where neither outputs b nor c match output a, LLM A is necessarily the only LLM whose output matches the output of the highest-ranked LLM. Thus, in some embodiments, as output a matches itself, the lowest-cost LLM matching outputs with the highest-ranked LLM may be the same LLM. In other words, the outputs from each LLM are compared to identify the lowest-cost LLM that produced an accurate output.

Next, at block 310, the query 250 is mapped to this lowest-cost LLM in the model routing database by creating a new model routing database entry. Thus, subsequent queries similar to the received query 250 will match with this new entry. The mapped LLM in the new entry may then be used to process these subsequent similar queries. As the new model routing database entry maps the query 250 to the lowest-cost LLM that produced an accurate output, subsequent similar queries will use this mapped LLM so as to use the lowest costs while still producing an accurate output. This LLM mapping saves on overall costs and computational resource usage, improving system efficiency. The output from this mapped LLM may then be provided as a response to the query 250 as set forth in block 210 of FIG. 2.

In some embodiments, prior to deployment for use in servicing queries 250, the model routing database may be prepopulated with mappings between various sample queries and a corresponding model. This prepopulating may improve initial performance by alleviating the need for running significant amounts of incoming queries 250 using all LLMs so as to populate the model routing database in a live environment. In some embodiments, the model routing database may be prepopulated to include sample queries 250 to address potential inaccurate outputs from otherwise higher-accuracy models. Returning to the examples above with LLMs A, B, and C, assume that, for a given sample query 250, output a was inaccurate while outputs b and c are accurate. Here, outputs b and c do not match output a. To prevent similar subsequent queries 250 from being issued to LLM A, potentially producing inaccurate outputs, an entry may be prepopulated in the model routing database that maps this sample query 250 to model C, the lowest cost LLM that produced an accurate response.

Although the processes of FIGS. 2 and 3 are described in combination with each other, readers will appreciate that these approaches may also be used independent of each other. For example, in some embodiments, processing a query 250 using an LLM as described in block 210 of FIG. 2 may include processing the query 250 using any LLM without the model routing aspects described in FIG. 3. As another example, in some embodiments, the model routing approaches set forth in FIG. 3 may be performed without the caching approaches using time-relative expressions of FIG. 2.

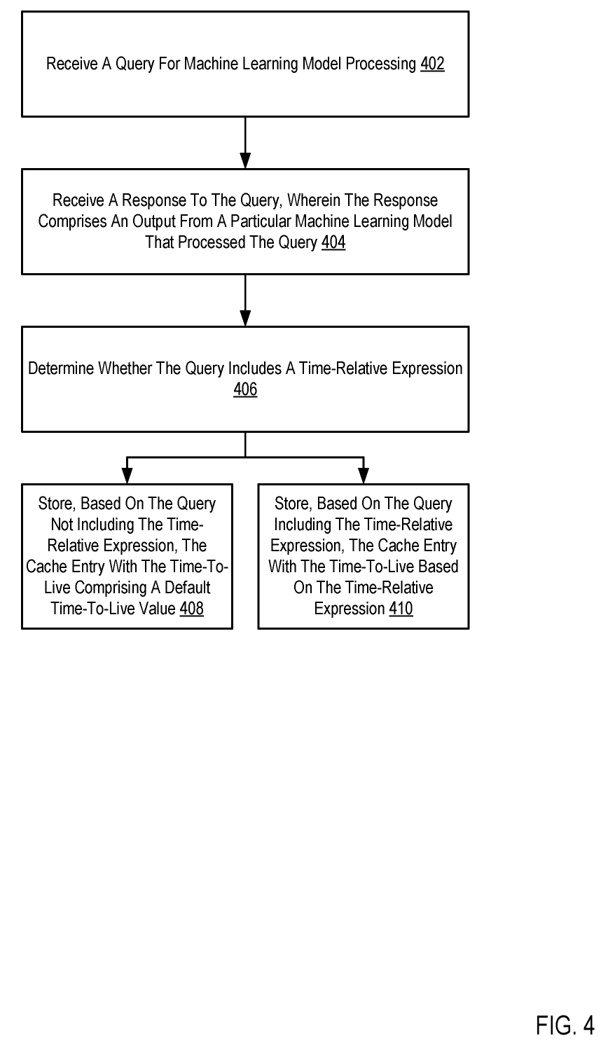

For further explanation, FIG. 4 sets forth a flowchart of an example method of reducing resource utilization in machine learning model processing in accordance with some embodiments of the present disclosure. The method of FIG. 4 may be performed, for example, by the query processing module 107 of FIG. 1. The method of FIG. 4 includes receiving 402 a query for machine learning model processing. The query includes some data that will be provided as input to some machine learning model so as to generate some output. For example, in some embodiments, the query may include a query to be processed using an LLM or another machine learning model as can be appreciated. Accordingly, in some embodiments, the query may include a natural language expression, such as a question or another request for information as can be appreciated. In some embodiments, the query may be received 402 via a natural language interface of a system operatively coupled to one or more machine learning models that may be used to process the query.

The method of FIG. 4 also includes receiving 404 a response to the query, wherein the response comprises an output from a particular machine learning model that processed the query. In the method of FIG. 4, it is assumed that a cache does not store a response to a previously received query similar to the received 402 query. Accordingly, as a response cannot be loaded from the cache to serve as a response to the query, the query must instead be processed by some machine learning model so as to produce a response.

In some embodiments, the particular machine learning model may include a predefined or predesignated machine learning model. In some embodiments, the particular machine learning model may include a model selected or identified from multiple machine learning models, to be described in further detail below. Accordingly, the response includes an output generated by the particular machine learning model in response to receiving an input that includes the query and potentially other data.

The method of FIG. 4 also includes determining 406 whether the query includes a time-relative expression. A time-relative expression is a natural language expression, such as a word or phrase, that indicates that the query is to be evaluated relative to the time at which the query is provided, received, and/or processed. Thus, similar or identical queries with a time-relative expression may produce different results depending on when the query is provided, received, and/or processed. As an example, a query asking, “What was yesterday’s closing stock market value?” will have different results depending on what day the query is provided, received, and/or processed. In this example, “yesterday” serves as a time-relative expression.

In some embodiments, determining 406 whether the query includes the time-relative expression includes providing the query as input to a machine learning model that provides, as output, data describing whether the query includes a time-relative expression. For example, in some embodiments, this machine learning model may include an LLM so as to leverage the ability of LLMs to process natural language. In this example, the query may be included in a prompt to the LLM to determine whether the query includes a time-relative expression. In some embodiments, the output from this machine learning model may include an indication as to whether the query includes a time-relative expression. In some embodiments, the output from this machine learning model may include a time window (e.g., time-to-live value) or duration for which a response to the query will be applicable. Other approaches may also be used to determine 404 whether the query includes a time-relative expression.

In some embodiments, a cache entry including the received response may then be stored with a time-to-live value dependent on whether the query includes a time-relative expression. Accordingly, in some embodiments, the method of FIG. 4 also includes: storing 408, based on the query not including the time-relative expression, the cache entry with a TTL comprising a default time-to-live value; and storing 410, based on the query including the time-relative expression, the cache entry with the time-to-live based on the time-relative expression.

In other words, where the query does not include a time-relative expression, the cache entry including the received 404 response will be assigned a default TTL. Otherwise, the cache entry will be assigned a TTL based on the included time-relative expression. For example, in some embodiments, a machine learning model used to determine 406 whether the query includes a time-relative expression may provide, as output, a duration or time window that the received response will be applicable to the query. Returning to the example above, for the query “What was yesterday’s closing stock market value?” the machine learning model may provide an output indicating that the response will be applicable until the end of the day. Thus, a cache entry may be stored 410 with a TTL that expires at the end of the current day.

In some embodiments, the query may be mapped to the cache entry using a vector database. The vector database may store an embedding of the query and an indication of the corresponding response in cache. Readers will appreciate that, in some embodiments, eviction of a cache entry (e.g., due to TTL expiration or based on other criteria) may cause the corresponding vector database entry to also be removed. The embeddings stored in the vector database may be compared to embeddings of subsequently received queries to determine whether a subsequently received query is similar to some query having a response stored in cache. This allows for cached responses to be provided in response to these similar queries rather than fully processing the similar queries using a machine learning model.

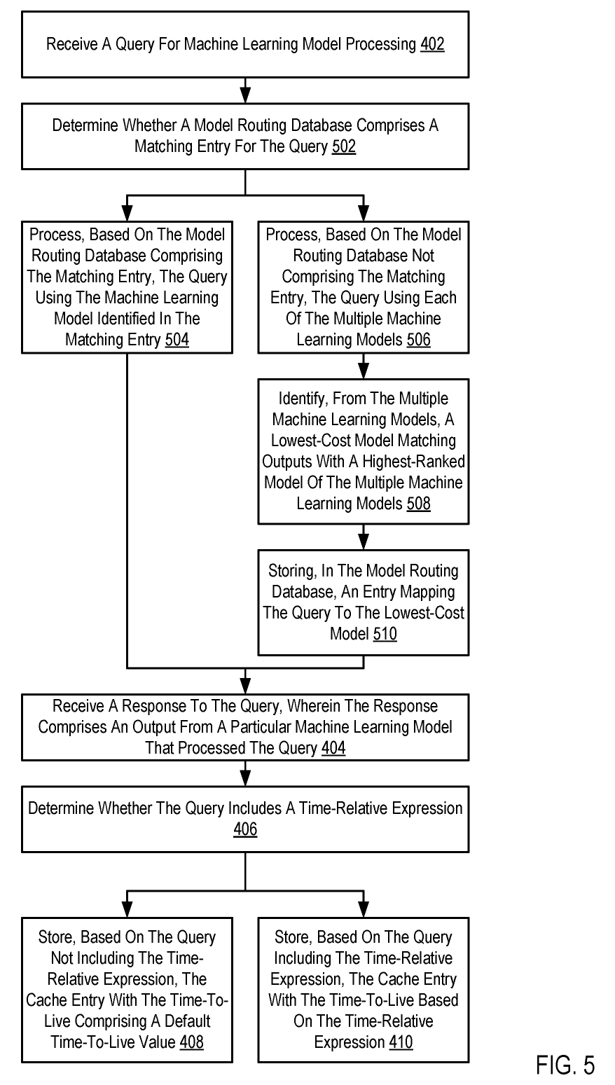

For further explanation, FIG. 5 sets forth a flowchart of another example method of reducing resource utilization in machine learning model processing in accordance with some embodiments of the present disclosure. The method of FIG. 5 is similar to FIG. 4 in that the method of FIG. 5 also includes: receiving 402 a query for machine learning model processing; receiving 404 a response to the query, wherein the response comprises an output from a particular machine learning model that processed the query; determining 406 whether the query includes a time-relative expression; storing 408, based on the query not including the time-relative expression, the cache entry with a TTL comprising a default time-to-live value; and storing 410, based on the query including the time-relative expression, the cache entry with the time-to-live based on the time-relative expression.

The method of FIG. 5 differs from FIG. 4 in that the method of FIG. 4 also includes determining 502 whether a model routing database comprises a matching entry for the query. The model routing database includes multiple entries each mapping a sample query to one or multiple machine learning model that may be used in processing the received 402 query. For example, the model routing database may include a vector database mapping embeddings of sample queries to a corresponding machine learning model. In some embodiments, an entry in the model routing database may match the query where the embedding of the sample query in the entry has a degree of similarity relative to the embedding of the query exceeding some threshold value. In other words, an entry in the model routing database may match the query where the distance between the embeddings of the query and the sample query in the entry falls below some threshold value.

Where the model routing database includes a matching entry, the query may be processed using the machine learning model identified in the entry. Accordingly, in some embodiments, the method of FIG. 5 also includes processing 504, based on the model routing database comprising the matching entry, the query using the machine learning model identified in the matching entry. Here, the identified machine learning model serves as the particular machine learning model from which the response was received 404.

Where the model routing database does not include a matching entry, an entry may be created so that subsequently received queries similar to the received 402 query may be processed using the lowest-cost machine learning model that will produce an accurate result. Accordingly, in some embodiments, the method of FIG. 5 also includes: processing 506, based on the model routing database not comprising the matching entry, the query using each of the multiple machine learning models. Thus, the query may be provided to each of multiple machine learning models to generate, for each machine learning model, a corresponding output.

The method of FIG. 5 also includes identifying 508, from the multiple machine learning models, a lowest-cost model matching outputs with a highest-ranked model of the multiple machine learning models. In some embodiments, each machine learning model may be presumed to have been classified with a descriptor indicating the cost (e.g., a financial cost and/or a computational resource expenditure) associated with processing a query using that machine learning model. Moreover, in some embodiments, each machine learning model may be presumed to have been classified with a descriptor indicating the accuracy of that machine learning model, such as a ranking.

Thus, the output from the highest-ranked machine learning model is compared against the outputs from the other machine learning models to identify any output matching (e.g., similar to) the output from the highest-ranked machine learning model. If an output from one or more other models matches the output from the highest-ranked machine learning model, the lowest-cost model of these one or more models is identified 508. If no other output matches the output from the highest-ranked machine learning model, the highest-ranked machine learning model is identified 508 as the lowest-cost model by virtue of its output matching itself.

The method of FIG. 5 also includes storing 510, in the model routing database, an entry mapping the query to the lowest-cost model (e.g., the model identified 508 as described above). Thus, subsequently received queries similar to the received 402 query will have a matching entry in the model routing database. This storing of the appropriate model name in the database may then cause these subsequently received queries to be processed by this lowest-cost model, reducing overall costs while maintaining accuracy of the response.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine-readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a first query for machine learning model processing;
receiving a response to the first query, wherein the response comprises an output from a particular machine learning model that processed the first query;
determining, via natural language processing performed via a computer, that the first query includes a time-relative expression;
storing a cache entry comprising the response to the first query and a time-to-live;
receiving, at a time within the time-to-live, a second query for machine learning model processing;
semantically analyzing the second query to determine that the second query has a similarity to the first query that exceeds a threshold value;
retrieving the response from the cache entry; and
transmitting the retrieved response to be an answer to the second query.

2. The method of claim 1, further comprising determining the time-to-live based on the time-relative expression.

3. The method of claim 1, further comprising:
receiving a third query for machine learning model processing;
receiving a response to the third query, wherein the response comprises an output from a particular machine learning model that processed the third query;
determining, via natural language processing performed via a computer, that the third query does not include a time-relative expression; and
storing a cache entry comprising the response to the third query, wherein the cache entry is stored with a default time-to-live.

4. The method of claim 1, wherein the semantic analyzing of the second query comprises comparing embeddings representing the second query to embeddings stored in a cache to determine that the second query has the similarity to the first query that exceeds a threshold value.

5. The method of claim 1, further comprising determining that a model routing database comprises a matching entry for the first query,
wherein the model routing database comprises multiple entries each mapping a sample query of multiple sample queries to a machine learning model of multiple machine learning models, and
wherein the particular machine learning model that processes the first query is selected for the processing of the first query based on being identified in the matching entry of the model routing database.

6. The method of claim 1, further comprising:
determining that a model routing database comprises no matching entry for the first query,
processing the first query using each of multiple machine learning models;
identifying, from the multiple machine learning models, a lowest-cost model that matches outputs with a highest-ranked model of the multiple machine learning models; and
storing, in the model routing database, a first entry that maps the first query to the lowest-cost model.

7. The method of claim 6, further comprising:
receiving a third query;
semantically analyzing the third query to determine that no responses for the third query are stored in cache;
determining that the first entry of the model routing database has a similarity to the third query that exceeds a predetermined threshold value; and
inputting the third query into the lowest-cost model to produce an output that is to be used as a response to the third query.

8. A computer system comprising:
a processor set;
one or more computer-readable storage media; and
program instructions stored on the one or more storage media to cause the processor set to perform operations comprising:
receiving a first query for machine learning model processing;
receiving a response to the first query, wherein the response comprises an output from a particular machine learning model that processed the first query;
determining, via natural language processing performed via a computer, that the first query includes a time-relative expression;
storing a cache entry comprising the response to the first query and a time-to-live;
receiving, at a time within the time-to-live, a second query for machine learning model processing;
semantically analyzing the second query to determine that the second query has a similarity to the first query that exceeds a threshold value;
retrieving the response from the cache entry; and
transmitting the retrieved response to be an answer to the second query.

9. The computer system of claim 8, wherein the operations further comprise determining the time-to-live based on the time-relative expression.

10. The computer system of claim 8, wherein the operations further comprise:
receiving a third query for machine learning model processing;
receiving a response to the third query, wherein the response comprises an output from a particular machine learning model that processed the third query;
determining, via natural language processing performed via a computer, that the third query does not include a time-relative expression; and
storing a cache entry comprising the response to the third query, wherein the cache entry is stored with a default time-to-live.

11. The computer system of claim 8, wherein the semantic analyzing of the second query comprises comparing embeddings representing the second query to embeddings stored in a cache to determine that the second query has the similarity to the first query that exceeds a threshold value.

12. The computer system of claim 8, wherein the operations further comprise determining that a model routing database comprises a matching entry for the first query,
wherein the model routing database comprises multiple entries each mapping a sample query of multiple sample queries to a machine learning model of multiple machine learning models, and
wherein the particular machine learning model that processes the first query is selected for the processing of the first query based on being identified in the matching entry of the model routing database.

13. The computer system of claim 8, wherein the operations further comprise:
determining that a model routing database comprises no matching entry for the first query,
processing the first query using each of multiple machine learning models;
identifying, from the multiple machine learning models, a lowest-cost model that matches outputs with a highest-ranked model of the multiple machine learning models; and
storing, in the model routing database, a first entry that maps the first query to the lowest-cost model.

14. The computer system of claim 13, wherein the operations further comprise:
receiving a third query;
semantically analyzing the third query to determine that no responses for the third query are stored in cache;
determining that the first entry of the model routing database has a similarity to the third query that exceeds a predetermined threshold value; and
inputting the third query into the lowest-cost model to produce an output that is to be used as a response to the third query.

15. A computer program product comprising:
one or more computer-readable storage media; and
program instructions stored on the one or more storage media to perform operations comprising:
receiving a first query for machine learning model processing;
receiving a response to the first query, wherein the response comprises an output from a particular machine learning model that processed the first query;
determining, via natural language processing performed via a computer, that the first query includes a time-relative expression;
storing a cache entry comprising the response to the first query and a time-to-live;
receiving, at a time within the time-to-live, a second query for machine learning model processing;
semantically analyzing the second query to determine that the second query has a similarity to the first query that exceeds a threshold value;
retrieving the response from the cache entry; and
transmitting the retrieved response to be an answer to the second query.

16. The computer program product of claim 15, wherein the operations further comprise determining the time-to-live based on the time-relative expression.

17. The computer program product of claim 15, wherein the operations further comprise:
receiving a third query for machine learning model processing;
receiving a response to the third query, wherein the response comprises an output from a particular machine learning model that processed the third query;
determining, via natural language processing performed via a computer, that the third query does not include a time-relative expression; and
storing a cache entry comprising the response to the third query, wherein the cache entry is stored with a default time-to-live.

18. The computer program product of claim 15, wherein the semantic analyzing of the second query comprises comparing embeddings representing the second query to embeddings stored in a cache to determine that the second query has the similarity to the first query that exceeds a threshold value.

19. The computer program product of claim 15, wherein the operations further comprise determining that a model routing database comprises a matching entry for the first query,
wherein the model routing database comprises multiple entries each mapping a sample query of multiple sample queries to a machine learning model of multiple machine learning models, and
wherein the particular machine learning model that processes the first query is selected for the processing of the first query based on being identified in the matching entry of the model routing database.

20. The computer program product of claim 15, wherein the operations further comprise:
determining that a model routing database comprises no matching entry for the first query,
processing the first query using each of multiple machine learning models;
identifying, from the multiple machine learning models, a lowest-cost model that matches outputs with a highest-ranked model of the multiple machine learning models; and
storing, in the model routing database, a first entry that maps the first query to the lowest-cost model.
